(19) United States
(12) Patent Application Publication
(10) Pub. No.: US 2005/0285331 A1
(43) Pub. Date: Dec. 29, 2005

(54) Sheet cartridge

(75) Inventor: Wen-Chen Wu, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: International Games System Co., Ltd

(21) Appl. No.: 10/994,059

(22) Filed: Nov. 19, 2004

(30) Foreign Application Priority Data
Jun. 24, 2004 (TW) 93118349

(51) Int. Cl. B41J 15/04; B41J 13/26; B41J 13/10; B41J 11/52; B41J 11/50; B65H 29/38; B41J 15/18; B41J 15/20

(52) U.S. Cl. 271/177

(57) ABSTRACT

A sheet cartridge, e.g. a bill cartridge, is designed for storing sheets in an automatic machine. The sheet cartridge has a housing and separators for defining a temporary space and a storage space. The housing has one or more patterned openings corresponding to pushing blocks of the automatic machine outside the sheet cartridge. The pushing blocks pushes sheets in the temporary space across the separators into the storage space via the corresponding openings so that the sheets are safe when the sheet cartridge is removed from the automatic machine.

### RELATED APPLICATIONS

The present application is based on, and claims priority from, Taiwan Application Serial Number 93118349, filed Jun. 24, 2004, the disclosure of which is hereby incorporated by reference herein in its entirety.

### BACKGROUND OF THE INVENTION

1. Field of Invention

The invention relates to a sheet cartridge in an automatic machine and, in particular, to a sheet cartridge ensuring that stored sheets do not get lost when the sheet cartridge is removed form the automatic machine.

2. Related Art

With advances in electronic and mechanical technologies, there are more automatic machines being invented to improve human life. The industrial development also increases the costs for manpower. Many simple routine jobs are done automatically. For example, vending machines originally invented for selling drinks and snacks have been developed to sell tickets, exchange money, save money, pay parking fees, and even the electronic banking that has become popular nowadays.

Due to the variety of in the application of automatic machines, more high-prices merchandises or services are also used in automatic machines. Aside from coins, bills with high values play more important roles in daily life. However, bills, checks, tickets or other valued certificates have huge differences from coins in use. Therefore, it is necessary to provide a mechanism on automatic machines that can process bills to satisfy different needs.

The automatic machine for processing bills is often made of several parts. For example, determining the value of a bill, recognizing whether a bill is true or fake, moving bills, and storing bills are common important mechanisms. Since bills have a physical size. After a certain time, somebody has to pick up these valued certificates from the automatic machine.

To prevent the collecting personnel from stealing, losing, or other possible disputes during the collection process, many mechanisms have been invented. One of them is the sheet cartridge with a lock. The collecting personnel obtain a locked sheet cartridge from the automatic machine and cannot access the bills contained therein.

However, there are many problems in the sheet cartridge to be solved. For example, if the design is not accurate enough or the structure is too complicated, the cost of the sheet cartridge may be too high. Moreover, one has to take into account the compatibility and security between the sheet cartridge and automatic machines.

Therefore, it would be highly desirable if a sheet cartridge with low cost and high compatibility with the automatic machine can be invented. It will greatly increase the use of automatic machines and improve human life.

### SUMMARY OF THE INVENTION

An objective of the invention is to provide a sheet cartridge for storing sheets of paper. The sheet cartridge can be stored in an automatic machine or taken off from it. When the sheet cartridge is taken off from the automatic machine, its structure can protect the sheets stored therein.

According to a preferred embodiment of the invention, a sheet cartridge is provided for an automatic processing device, such as an automatic vending machine, to store a certain type of sheets such as bills. The automatic processing device has a pushing block and a sheet feeding track. The pushing block has at least one protruding block to push sheets forward or backward according to a control command. Moreover, the sheet feeding track allows the certain type of sheets to move within the automatic processing device. The sheet cartridge is stored in a removable way inside the automatic device.

The sheet cartridge has a first housing, at least one stop block, and a second housing. The first housing contains a sheet feeding part and an accepting part. The sheet feeding part has a sheet entrance. The accepting part has at least one patterned opening. When the sheet cartridge is stored in the automatic device, the sheet entrance faces the sheet feeding track to receive the certain type of sheets. The patterned opening faces and corresponds to the protruding block.

The stop block is connected to the first housing. One surface of the stop block and the first housing together form a temporary space for accommodating the certain type of sheets entering from the sheet entrance.

The second housing is connected to the stop block. Part of the second housing and the other surface of the stop block together form a storage space. The storage space is in connection with the temporary space.

When the control command is enabled, the protruding block move in the sheet pushing direction and goes through the patterned opening, pushing the certain type of sheets in the temporary space into the storage space.

The sheet cartridge can be locked while still being able to operate with the automatic processing device, i.e. sending sheets into the storage space. Therefore, the invention indeed provides a sheet cartridge with a high compatibility with automatic machines.

In accord with the above description, the invention has at least the following advantages. First, the sheet cartridge can operate with an automatic processing device to achieve the basic functions of a sheet cartridge. Secondly, the sheet cartridge has a simple structure and low cost. Moreover, when the sheet cartridge is locked, it can protect sheet, such as bills, stored therein.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of an automatic machine;

FIG. 2 is a schematic view of feeding sheets into an automatic machine;

FIG. 3 is a schematic view of a sheet storage module according to a preferred embodiment of the invention;

FIG. 4 is a three-dimensional schematic view of the sheet cartridge in FIG. 3;

FIG. 5(a) is a cross-sectional view of a state during the operation of the sheet cartridge;

FIG. 5(b) is a cross-sectional view of another state during the operation of the sheet cartridge;

FIG. 6(a) is a cross-sectional view of the interaction between the sheet cartridge and the pushing block in a first stage;

FIG. 6(b) is a cross-sectional view of the interaction between the sheet cartridge and the pushing block in a second stage;

FIG. 6(c) is a cross-sectional view of the interaction between the sheet cartridge and the pushing block in a third stage;

FIG. 7 is a schematic view of the interaction between the sheet cartridge and the pushing block;

FIG. 8(a) is a schematic view showing the relation among the temporary space, the storage space, and the stop block;

FIG. 8(b) is a schematic view showing the relative relation between one stop block shape embodiment and the sheets;

FIG. 8(c) is a schematic view showing the relative relation between another stop block shape embodiment and the sheets;

FIG. 9(a) shows an embodiment of the patterned openings; and

FIG. 9(b) shows another embodiment of the patterned openings.

### DETAILED DESCRIPTION OF THE PREFERRED EMBODIMENT

### Preferred Embodiment

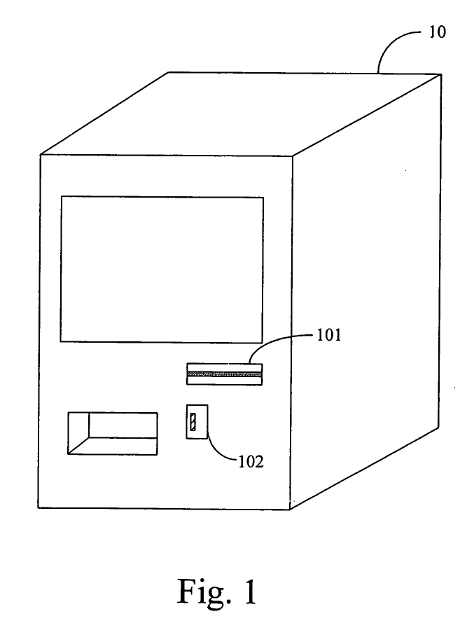

Please refer to FIG. 1, which shows an automatic machine 10 according to a preferred embodiment of the invention. The automatic machine 10 has a sheet entrance 101 and a coin inlet 102. Examples of such an automatic machine 10 include automatic vending machines, monetary trading machine such as ATM and bill exchangers. The sheets received at the sheet entrance 101 include flat sheets such as bills, tickets, and various kinds of valued certificates.

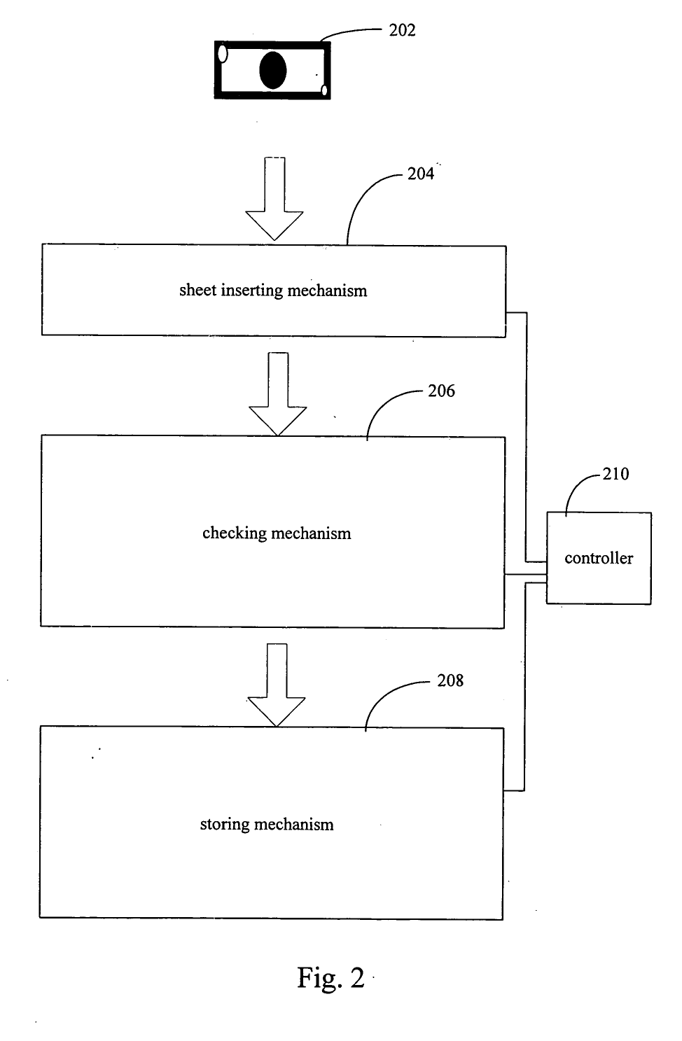

With reference to FIG. 2, sheets 202 such as bills enter via a sheet inserting mechanism 204, such as an inlet and the connected transmitting track, into the automatic machine 10. The sheets 204 are then examined by a checking mechanism 206 to determine whether they are of a predetermined type of sheets, e.g. checking their face values or whether they are fake. The checking is done by employing such techniques as magnetic ink, hidden magnetic stripes, or optical recognition. Finally, the qualified certain type of sheets are moved from the sheet feeding track to a storing mechanism 208. The above-mentioned action is controlled by a controller 210, which provides control commands to a stepping motor for driving the sheet feeding track or to a program for executing optical recognition.

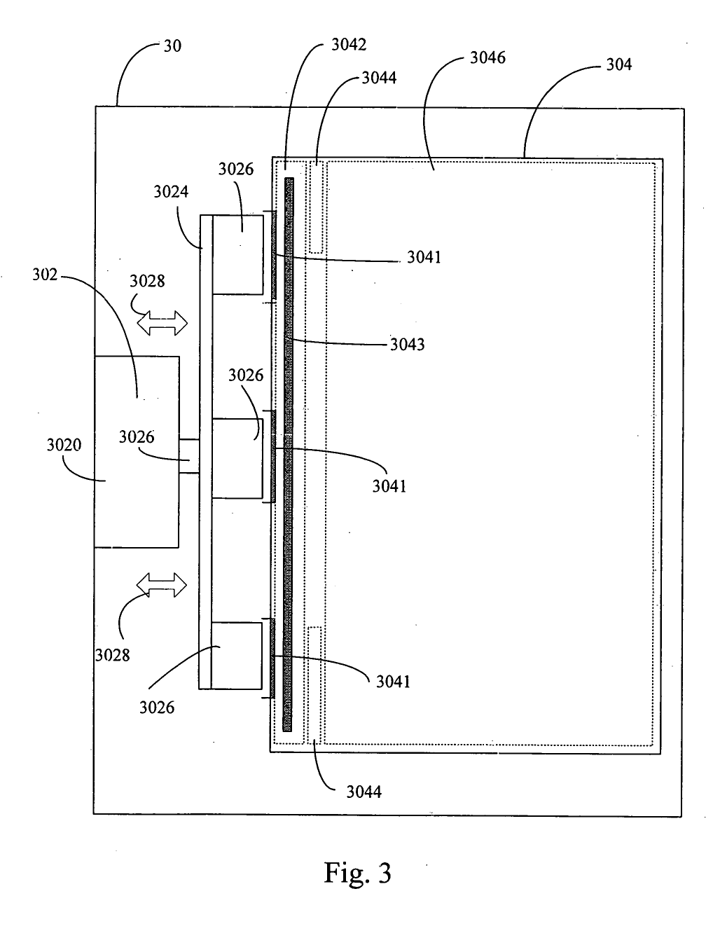

The storing module 208 in FIG. 2 is further explained with reference to FIG. 3. In the drawing, the storing module 30 contains a pushing block 302 and a sheet cartridge 304. The pushing block 302 has a pushing device 3020, an axle 3025, a base 3024, and several protruding blocks 3026. In addition, the pushing device 3020 has a stepping motor and a control circuit. The control circuit receives a control signal from the automatic machine to control the stepping motor, thereby driving the axle 3025, the base 3024, and the protruding blocks 3026 for moving in the direction of feeding sheets 3028.

Moreover, the sheet cartridge 304 has a first housing 3042, a separator comprised of at least one stop block 3044, and a second housing 3046. The first housing 3042 has a sheet feeding part and an accepting part corresponding to the protruding blocks 3026. The sheet feeding part has a sheet entrance 3043. The accepting part has patterned openings 3041 corresponding to the protruding blocks 3026.

The sheet cartridge 304 is applicable in the automatic machine 10 shown in FIG. 1. Normally, the sheet cartridge 304 is installed inside the automatic machine. In this case, the sheet entrance 3043 faces the sheet feeding track of the automatic device to receive sheets, and the patterned openings 3041 face and correspond to the protruding blocks 3026. When the sheets are loaded full, an operator takes the sheet cartridge 304 off the automatic machine 10 and brings it back to the company to retrieve the sheets stored therein.

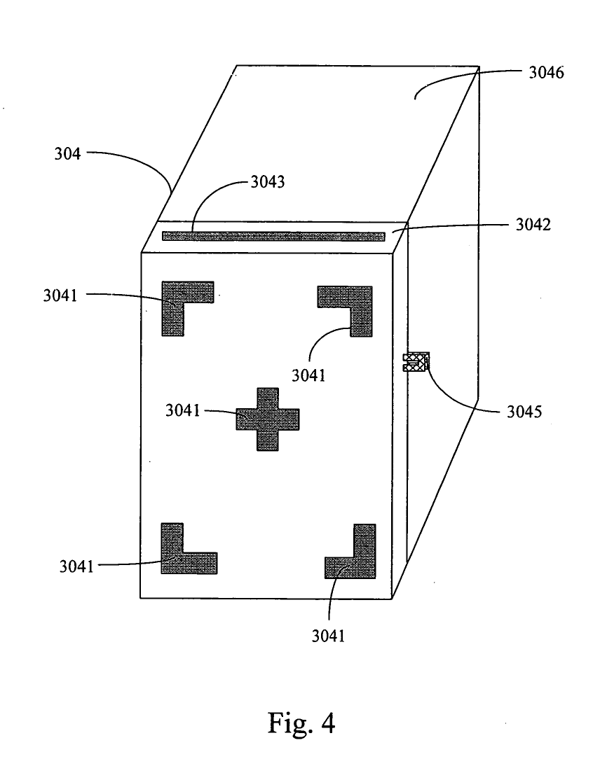

A three-dimensional view of the sheet cartridge 304 is shown in FIG. 4, where the numerals refer to the same matters as in FIG. 3. By comparing FIG. 4 with FIG. 3, one can clearly understand the structure of the sheet cartridge 304. To avoid the operator to touch the sheets stored in the sheet cartridge 304, a lock can be installed on the sheet cartridge 304.

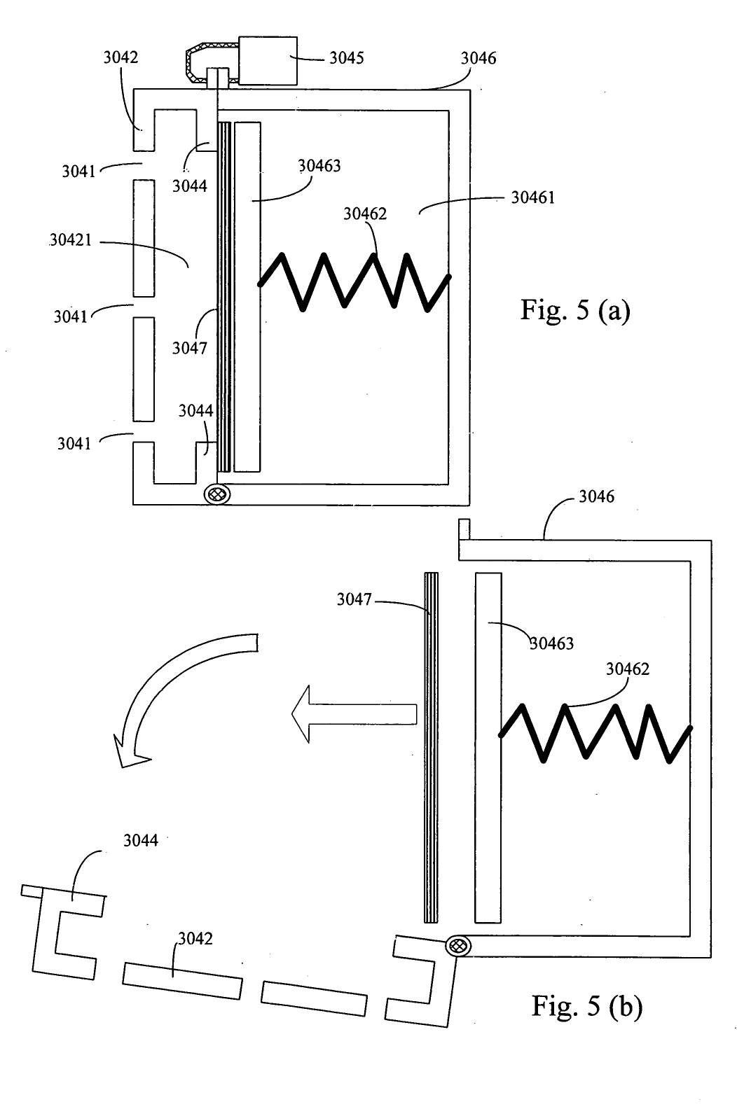

With reference to FIGS. 5(a) and 5(b), which show cross-sectional views of FIG. 4 in two different states, with the numerals referring to the same matters in FIG. 5. FIG. 5(a) shows the normal use state of the sheet cartridge 304. From the drawing, one sees that the first housing 3042 and one surface of the stop block 3044 form a temporary space 30421. The second housing 3046 and the other surface of the stop block 3044 form a storage space 30461. The sheets 3047 are normally stored in the storage space 30461.

For the convenience of collecting sheets, an elastic device 30462 is connected between the second housing 3046 and a stop board 30463, the structure of which presses the sheets 3047 between the stop block 3044 and the stop board 30463.

With reference to FIG. 5(b), to protect the sheets stored in the sheet cartridge 304, a lock device 305 is often installed on the sheet cartridge 304. Once the sheet cartridge 304 is brought back to the company and unlocked, it is in the opened state shown in the drawing. In this case, the manager can readily take out neatly collected sheets 3047.

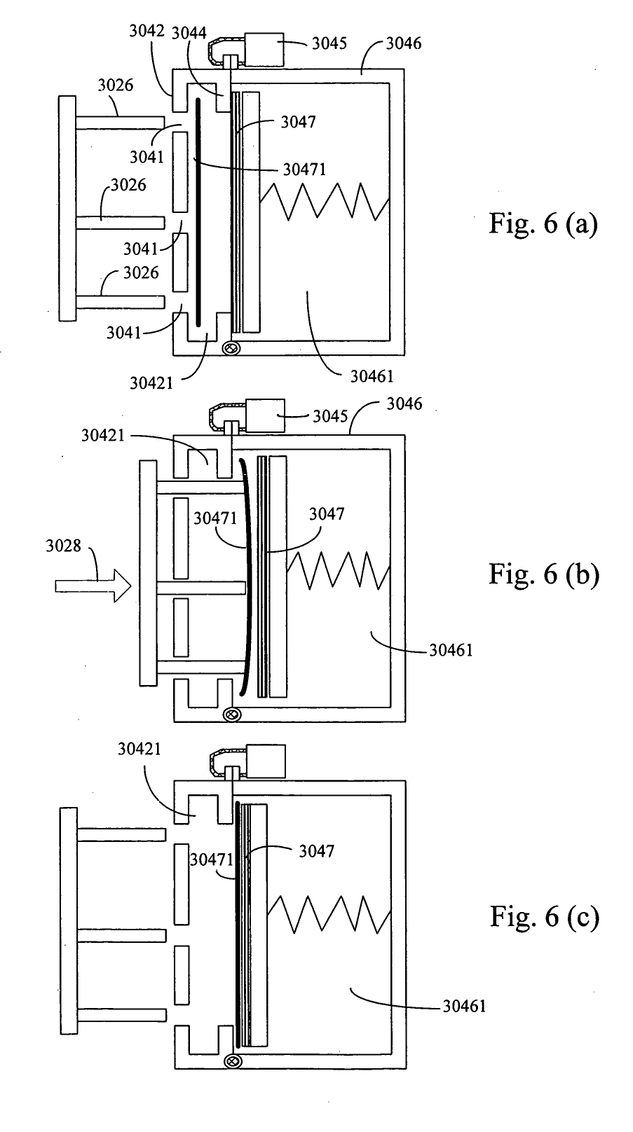

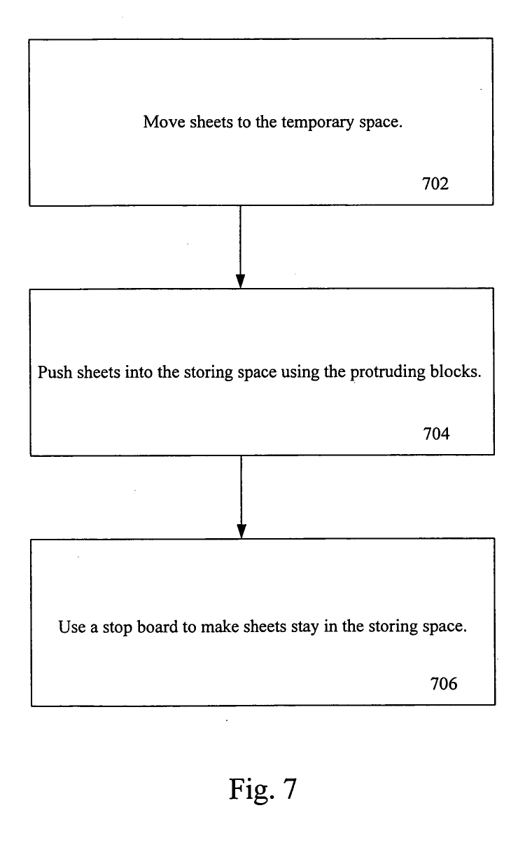

The cooperation between the pushing block 302 and the sheet cartridge 304 is shown in FIGS. 6(a) to 6(c) and FIG. 7. FIGS. 6(a) to 6(c) illustrate three states of interactions between the sheet cartridge 304 and the pushing block 302. FIG. 7 is a schematic flowchart of the process. The same numerals refer to the same or similar structures as in the previous figures and are not described again.

In FIG. 6(a), a sheet 30471 is moved from the sheet entrance of the sheet cartridge 304 to the temporary space 3041 via the sheet feeding track of the automatic machine (step 702). In FIG. 6(b), the protruding blocks 3026 of the pushing block move in the direction of feeding sheets 3028 according to the control command sent out by the controller 210. Since the sheet cartridge 304 has the patterned openings 3041 corresponding to the protruding blocks 3026, the protruding blocks 3026 go through the patterned openings 3041 into the temporary space 3041 as they proceed, pushing the sheets 30471 stored in the temporary space 3041 past the stop block 34 into the storage space 30461 (step 704). At this moment, the sheets 3047 originally between the stop board 30463 and the stop block 3044 are pushed further back.

Afterwards, the protruding blocks 3026 of the pushing block return to their original positions according to a control command. The elastic device 30462 presses against the stop board 30463, pushing the sheets 30471 and other sheets 3047 in the direction opposite to feeding. In this way, the sheets 30471 are smoothly moved from the temporary space 30421 to the storage space 30461 (step 706).

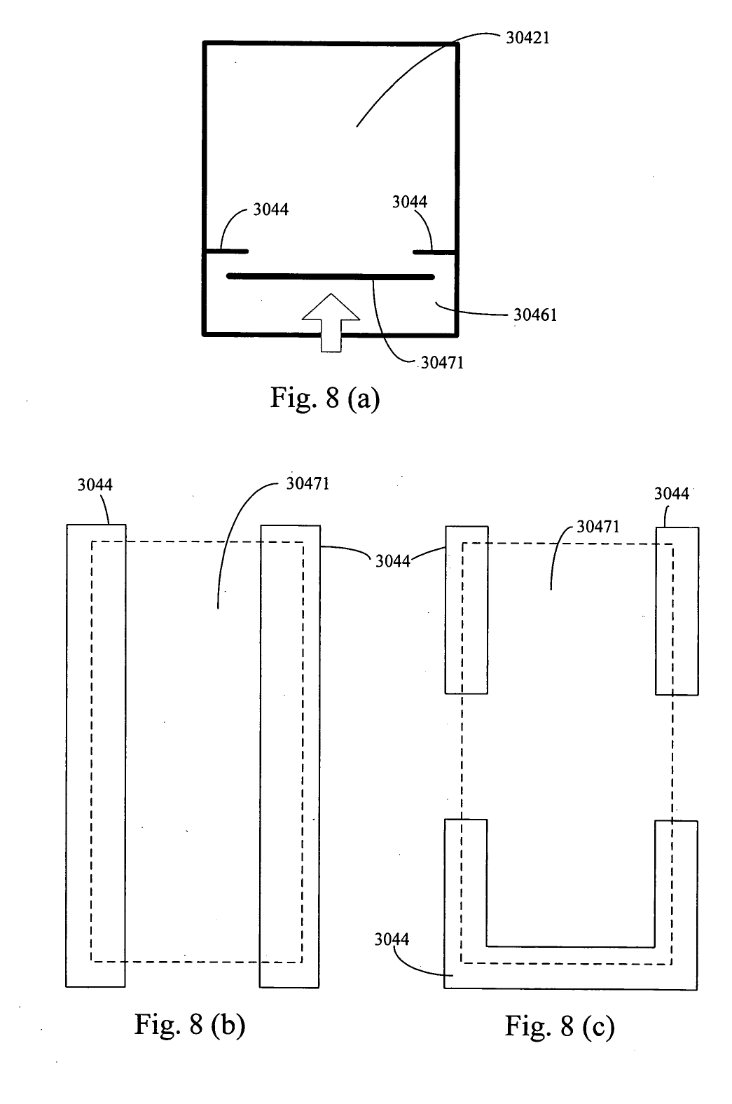

In the following, we use FIGS. 8(a) to 8(c) to describe the structure of the stop block 3044. The same numerals refer to the same or similar structures as in the previous figures and are not described again.

With reference to FIG. 8(a), the stop block 3044 is between the temporary space 30421 and the storage space 30461. After the sheets 30471 enter the temporary space 30421, the protruding blocks 3026 push the sheets 30471 in the sheet feeding direction 3028 to the storage space 30461. The action of the stop block 3044 can be clearly seen in the drawing.

Please refer to FIGS. 8(b) and 8(c), which describe the shape of the stop block from another perspective and the relation between the stop block 3026 and the sheets 30471. In FIG. 8(b), the stop block 3044 is made of two separate plates. In FIG. 8(c), the stop block 3044 is made of three separate plates. In other words, the primary purpose of the stop block 3044 is to let the sheets 30471 stay in the temporary space 30421 or the storage space 30461 when they are not pushed by the protruding blocks 3026. That is, any stop block 3044 in a combination of any shape and any number belongs to the scope of the invention.

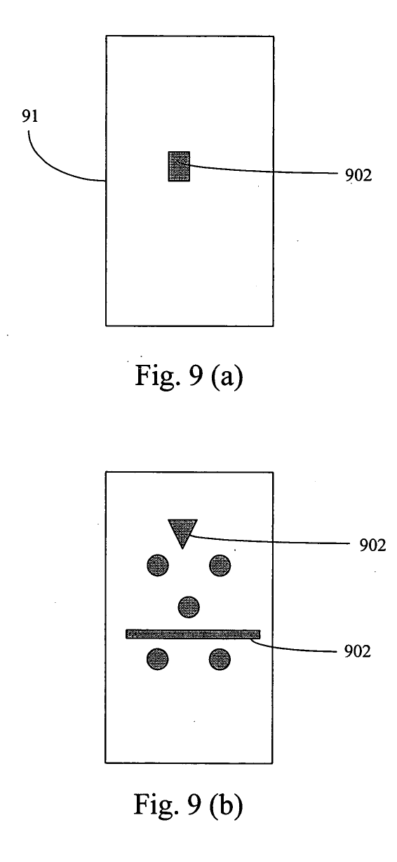

Please refer to FIGS. 9(a) and 9(b). Aside from many different variations of the stop block 3044, the patterned openings 3041 may have many different variations too. As long as the patterned openings 3041 match the shapes of the protruding blocks 3026 and are smaller than the size of the sheets, so that the sheets do not move out of the sheet cartridge 304, all the possible modifications belong to the scope of the invention. For example, in FIG. 9(a), the patterned opening 902 of the accepting part of the first housing is a rectangle. In FIG. 9(b), however, the patterned openings 3041 on the accepting part 91 have several geometric shapes or stripes.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A sheet cartridge used in an automatic processing device to store a plurality of certain sheets, the automatic processing device including a pushing block having at least one protruding block to move in a sheet feeding direction according to a control command and a sheet feeding track for at least one of the certain sheets to move in the automatic processing device, wherein the sheet cartridge is installed in the automatic device in a removable way and comprises:
a first housing containing a sheet feeding part and an accepting part, the sheet feeding part having a sheet entrance and the accepting part having at least one patterned opening, wherein when the sheet cartridge is installed inside the automatic device the sheet entrance faces the sheet feeding track to receive at least one of the certain sheets and the patterned opening faces and corresponds to at least one protruding block;
at least one stop block connected to the first housing, one surface of the stop block and part of the first housing constituting a temporary space for accommodating the certain sheets from the sheet entrance; and
a second housing connected to the stop block, the second housing and the other surface of the block constituting a storage space in connection with the temporary space;
wherein when the control command is enabled, the protruding block moves toward the sheet feeding direction and goes through the patterned opening, pushing the certain sheets in the temporary space into the storage space.

2. The sheet cartridge of claim 1, wherein the certain sheet is a currency bill.

3. The sheet cartridge of claim 1 further comprising a pressing device, which has an elastic device and a stop board, wherein one side of the elastic device is connected to the second housing and the other side is connected to the stop board, and, with the elastic device, the stop board pushes the certain sheets in the storage space toward the stop block.

4. The sheet cartridge of claim 3 further comprising a lock device connected to the second housing, wherein the certain sheets in the storage space are prevented from being taking away when the lock device is engaged and are removable by a manager when the lock device is unlocked.

5. The sheet cartridge of claim 4, wherein the size of the patterned opening is smaller than that of the certain sheets so that the certain sheets in the temporary space and the storage space is kept from being taken away via the patterned opening.

6. The sheet cartridge of claim 1, wherein the first housing and the second housing are formed as one body.

7. The sheet cartridge of claim 1, wherein the patterned opening is an opening with a geometrical shape selected from a circle and a triangle.

8. The sheet cartridge of claim 1, wherein the stop block defines an entrance connecting the temporary space and the storage space.

9. The sheet cartridge of claim 8, wherein the stop block has a plate shape.

10. The sheet cartridge of claim 1, wherein the protruding block is a stripe-like object.

11. The sheet cartridge of claim 1, wherein the protruding block is a plate-like object.

12. The sheet cartridge of claim 1, wherein the automatic processing device is an automatic vending machine.

13. The sheet cartridge of claim 1, wherein the automatic processing device is an exchange machine.

14. The sheet cartridge of claim 1, wherein the automatic processing device is a monetary trading machine.

15. An automatic processing device for receiving at least one certain type of sheets, the automatic processing device comprising:
a pushing block, which has at least one protruding block moving forward and backward according to a control command;
a sheet feeding track, which allows the certain type of sheets to move within the automatic machine;
a sheet cartridge, which includes:
a first housing containing a sheet feeding part and an accepting part, the sheet feeding part having a sheet entrance and the accepting part having at least one patterned opening, wherein when the sheet cartridge is installed inside the automatic device the sheet entrance faces the sheet feeding track to receive at least one of the certain sheets and the patterned opening faces and corresponds to at least one protruding block;
at least one stop block connected to the first housing, one surface of the stop block and part of the first housing constituting a temporary space for accommodating the certain sheets from the sheet entrance; and
a second housing connected to the stop block, the second housing and the other surface of the block constituting a storage space in connection with the temporary space;
wherein when the control command is enabled, the protruding block moves toward the sheet feeding direction and goes through the patterned opening, pushing the certain sheets in the temporary space into the storage space.

16. The automatic processing device of claim 15, wherein the certain sheet is a currency bill.

17. The automatic processing device of claim 15 further comprising a pressing device, which has an elastic device and a stop board, wherein one side of the elastic device is connected to the second housing and the other side is connected to the stop board, and, with the elastic device, the stop board pushes the certain sheets in the storage space toward the stop block.

18. The automatic processing device of claim 17 further comprising a lock device connected to the second housing, wherein the certain sheets in the storage space are prevented from being taking away when the lock device is engaged and are removable by a manager when the lock device is unlocked.

19. The automatic processing device of claim 18, wherein the size of the patterned opening is smaller than that of the certain sheets so that the certain sheets in the temporary space and the storage space is kept from being taken away via the patterned opening.

20. The automatic processing device of claim 15, wherein the first housing and the second housing are formed as one body.

21. The automatic processing device of claim 15, wherein the patterned opening is an opening with a geometrical shape selected from a circle and a triangle.

22. The automatic processing device of claim 15, wherein the stop block defines an entrance connecting the temporary space and the storage space.

23. The automatic processing device of claim 22, wherein the stop block has a plate shape.

24. The automatic processing device of claim 15, wherein the protruding block is a stripe-like object.

25. The automatic processing device of claim 15, wherein the protruding block is a plate-like object.

26. The automatic processing device of claim 15, wherein the automatic processing device is an automatic vending machine.

27. The automatic processing device of claim 15, wherein the automatic processing device is an exchange machine.

28. The automatic processing device of claim 15, wherein the automatic processing device is a monetary trading machine.

29. A bill cartridge comprising:
a housing, whose one surface has at least one patterned opening whose size is smaller than the size of the bill so that the bills stored in the housing is not removable from the housing via the patterned opening; and
a separator, which is connected to the housing to define a temporary space and a storage space;
wherein a pushing block outside the bill cartridge is employed to move through the patterned opening, pushing the bills stored in the temporary space across the separator into the storage space.

30. The bill cartridge of claim 29, wherein the separator is at least a stop block.

31. The bill cartridge of claim 30, wherein the housing further includes a lock device to prevent the bills in the storage space from being taken away.
